(19) United States
(12) Patent Application Publication
(10) Pub. No.: US 2004/0055696 A1
(43) Pub. Date: Mar. 25, 2004

(54) Method for manufacturing an iron golf club head

(75) Inventors: Herbert Reyes, Laguna Niguel, CA (US); Uday V. Deshmukh, Oceanside, CA (US); Karl A. Clausen, San Marcos, CA (US); Augustin W. Rollinson, Carlsbad, CA (US); Richard C. Helmstetter, Rancho Santa Fe, CA (US)

Correspondence Address: CALLAWAY GOLF C0MPANY, 2180 RUTHERFORD ROAD, CARLSBAD, CA, 92008-7328, US

(73) Assignee: Callaway Golf Company, Carlsbad, CA (US)

(21) Appl. No.: 10/065,150

(22) Filed: Sep. 20, 2002

(51) Int. Cl. B32B 31/04

(52) U.S. Cl. 156/242; 156/293

(57) ABSTRACT

A method for manufacturing a multiple material iron golf club head (20) is disclosed herein. The club head is preferably composed of three main components: a periphery member (22), a central member (24) and a face plate (26). The periphery member (22) is preferably composed of a high density material such as a iron-nickel tungsten alloy. The central member (24) is preferably composed of a bulk molding compound. The face plate (26) is preferably composed of a titanium alloy material. The iron golf club head (20) preferably has high moments of inertia Izz and Ixx.

### CROSS REFERENCE TO RELATED APPLICATIONS

Not Applicable

### FEDERAL RESEARCH STATEMENT

[Not Applicable]

### BACKGROUND OF INVENTION

1. Field of the Invention

The present invention relates to manufacturing iron golf clubs. More specifically, the present invention relates to a method for manufacturing a multiple material iron golf club.

2. Description of the Related Art

Irons are typically composed of a stainless steel or titanium material, and are typically cast or forged. Most golfers desire that their irons have a large sweet spot for greater forgiveness, a low center of gravity to get the ball in the air, a solid sound, reduced vibrations during impact, and a trim top line for appearance. Unfortunately, these desires are often in conflict with each other as it pertains to an iron.

The use of iron club heads composed of different materials has allowed some prior art irons to achieve some of these desires.

One example is U.S. Pat. No. 5,228,694 to Okumoto et al., which discloses an iron club head composed of a stainless steel sole and hosel, a core composed of a bulk molding compound or the like, a weight composed of a tungsten and polyamide resin, and an outer-shell composed of a fiber-reinforced resin.

Another example is set forth in U.S. Pat. Nos. 4,792,139, 4,798,383, 4,792,139 and 4,884,812, all to Nagasaki, et al., which disclose an iron club head composed of stainless steel with a fiber reinforced plastic back plate to allow for weight adjustment and ideal inertia moment adjustment.

Another example is U.S. Pat. No. 4,848,747 which discloses a metal iron club head with a carbon fiber reinforced plastic back plate to increase the sweet spot. A ring is used to fix the position of the back plate.

Another example is set forth in U.S. Pat. Nos. 4,928,972 and 4,964,640 which disclose an iron club head composed of stainless steel with a fiber reinforcement in a rear recess to provide a dampening means for shock and vibrations, a means for increasing the inertial moment, a means for adjusting the center of gravity and a means for reinforcing the back plate.

Another example is U.S. Pat. No. 5,190,290 to Take, which discloses an iron club head with a metal body, a filling member composed of a light weight material such as a plastic, and a fiber-reinforced resin molded on the metal body and the filling member.

Another example is U.S. Pat. No. 5,411,264 to Oku, which discloses a metal body with a backwardly extended flange and an elastic fiber face plate in order to increase the moment of inertia and minimize head vibrations.

Another example is U.S. Pat. No. 5,472,201 to Aizawa et al., which discloses an iron club head with a body composed of stainless steel, a face member composed of a fiber reinforced resin and a protective layer composed of a metal, in order to provide a deep center of gravity and reduce shocks.

Another example is U.S. Pat. No. 5,326,106 to Meyer, which discloses an iron golf club head with a metal blade portion and hosel composed of a lightweight material such as a fiber reinforced resin.

Another example is U.S. Pat. No. 4,664,383 to Aizawa et al., which discloses an iron golf club head with a metal core covered with multiple layers of a reinforced synthetic resin in order to provide greater ball hitting distance.

Another example is U.S. Pat. No. 4,667,963 to Yoneyama, which discloses an iron golf club head with a metal sole and a filling member composed of a fiber reinforced resins material in order to provide greater hitting distance.

The prior art fails to disclose an iron golf club head that is composed of multiple materials, has a low center of gravity, reduced vibrations, and a greater moment of inertia.

### SUMMARY OF INVENTION

The present invention provides a method for manufacturing a multiple material iron golf club head. The iron golf club head has a low center of gravity, a high moment of inertia, reduced vibrations and a solid feel and appearance.

One aspect of the present invention includes attaching a face plate to a periphery member to create a base assembly. Then, bonding a central member to the base assembly to create the finished iron golf club head.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF DRAWINGS

FIG. 1 is an exploded view of an iron club head.

FIG. 2 is a side exploded view of an iron club head.

FIG. 3 is a front plan view of the an iron club head.

FIG. 4 is a rear plan view of the iron club head of FIG. 1.

FIG. 5 is a toe side view of the iron club head of FIG. 1.

FIG. 6 is a heel side view of the iron club head of FIG. 1.

FIG. 7 is a top plan view of the iron club head of FIG. 1.

FIG. 8 is a bottom plan view of the iron club head of FIG. 1.

FIG. 9 is a flow chart of the main manufacturing process.

FIG. 9A is a continuation of the flow chart of FIG. 9

FIG. 10 is a flow chart of a periphery member formation process.

FIG. 11 is a flow chart of an alternative periphery member formation process.

FIG. 12 is a flow chart of a central member formation process.

FIG. 13 is a flow chart of an alternative central member formation process.

### DETAILED DESCRIPTION

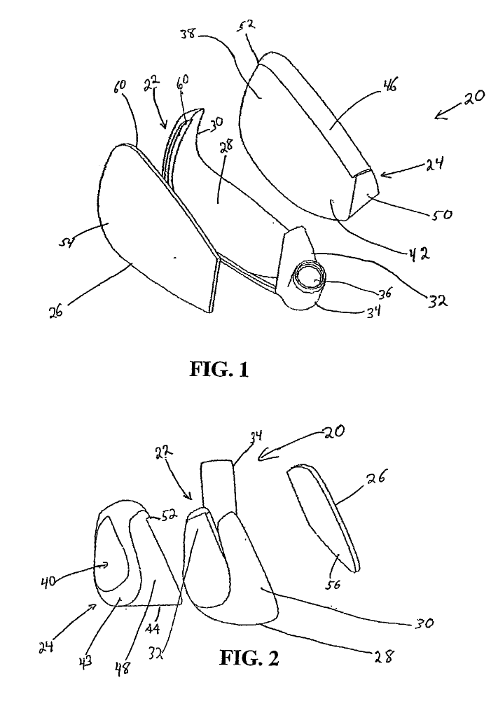

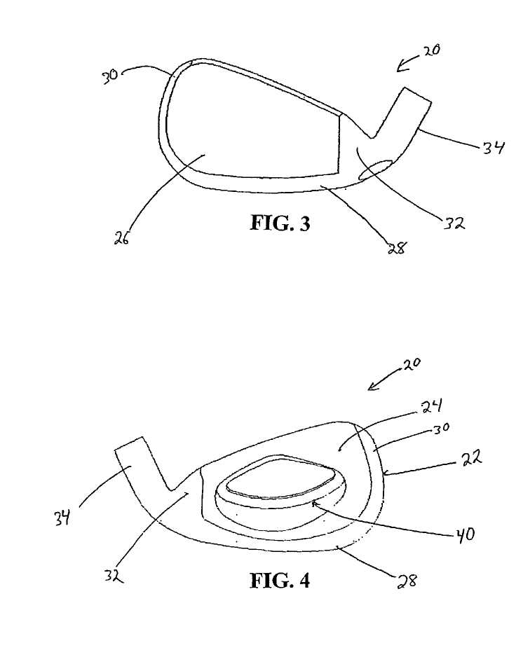

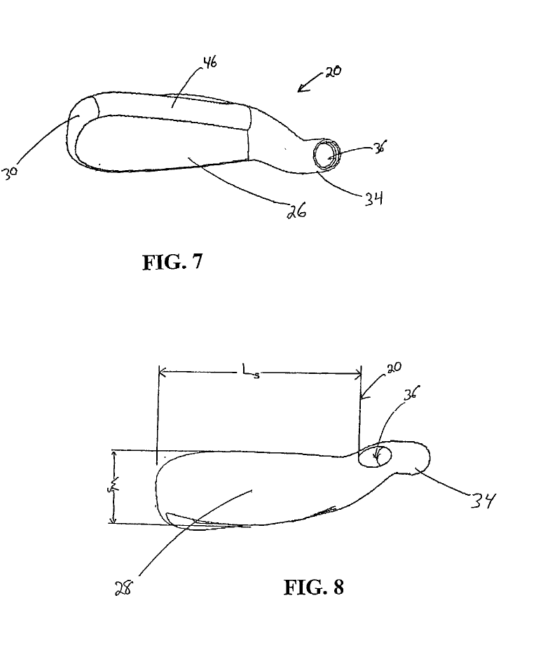

As shown in FIGS. 1-8, an iron golf club head is generally designated 20. The club head 20 is preferably composed of three main components: a periphery member 22, a central member 24 and a face plate 26. The club head 20 can range from a 1-iron to a lob-wedge, with the loft angle preferably ranging from fifteen degrees to sixty degrees. The three main components are assembled into the club head 20 using a process disclosed below.

The periphery member 22 is preferably composed of a material having a density greater than 7.86 grams per centimeter cubed (g/cm³). A preferred material is an iron-nickel-tungsten alloy having a density preferably ranging from 8.0 g/cm³ to 12.0 g/cm³, more preferably ranging from 10.0 g/cm³ to 11.0 g/cm³, and most preferably 10.5 g/cm³. An alternative material is a stainless steel material. Those skilled in the pertinent art will recognize that other materials may be used for the periphery member 22 without departing from the scope and spirit of the present invention.

The periphery member 22 has sole wall 28, a toe wall 30 extending upward from a toe end of the sole wall 28, a heel wall 32 extending upward from the sole wall 28 near a heel end of the sole wall 28, and a hosel 34 extending outward from the sole wall 28 at the heel end of the sole wall 28. The hosel 34 is preferably offset. The hosel 34 has a bore 36 for receiving a shaft, and the upper end of the hosel 34 preferably lies below an upper end of the toe wall 30 when the club head 20 is in the address position for striking a golf ball, not shown. The bore 36 preferably extends through the entire hosel 34 providing a short straight hollow hosel such as disclosed in U.S. Pat. No. 4,995,609, which pertinent parts are hereby incorporated by reference.

The sole wall 28 preferably has a cambered exterior surface, which contacts the ground during a golf swing. As shown in FIG. 8, the sole wall 28 has a width, Ws, that preferably ranges from 1.00 inch to 1.75 inch, and is most preferably 1.25 inch. The sole wall 28 also has a length, Ls, from a toe end to the beginning of the bore 36, which preferably ranges from 2.5 inches to 3.5 inches, and is most preferably 3.0 inches.

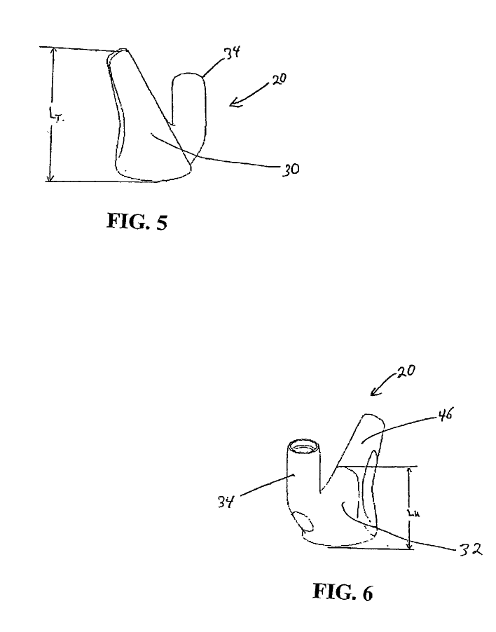

As shown in FIG. 5, the toe wall 30 preferably has a length, Lt, which preferably ranges from 1.5 inches to 2.5 inches, and is most preferably 2.0 inches. The toe wall 30 preferably has a width that tapers from a lower end to an upper end of the toe wall 30.

As shown in FIG. 6, the heel wall 32 preferably has a length, Lh, which preferably ranges from 0.5 inch to 1.5 inches, and is most preferably 1.0 inch. The heel wall 32 preferably has a width that tapers from a lower end to an upper end of the heel wall 32.

In general, the periphery member 22 provides the club head 20 with a greater moment of inertia due to its relatively large mass at the periphery of the club head 20. Further, mass attributable to the sole wall 28 lowers the center of gravity of the club head 20 to promote a higher trajectory during ball striking. The periphery member 22 is preferably 15% to 50% of the volume of the club head 20 and preferably 50% to 80% of the mass of the club head 20.

The central member 24 is composed of a non-metal material. Preferred materials include bulk molding compounds, sheet molding compounds, thermosetting materials and thermoplastic materials. A preferred bulk molding compound is a resinous material with reinforcement fibers. Such resins include polyesters, vinyl esters and epoxy. Such fibers include carbon fibers, fiberglass, aramid or combinations. A preferred sheet molding compound is similar to the bulk molding compounds, however, in a sheet form. A preferred thermoplastic material includes injection moldable materials integrated with fibers such as disclosed above. These thermoplastic materials include polyesters, polyethylenes, polyamides, polypropylenes, polyurethanes, and the like.

The central member 24 is primarily a support for the face plate 26, and thus the central member should be able to withstand impact forces without failure. The central member 24 also reduces vibrations of the club head 20 during ball striking. The central member 24 is preferably 25% to 75% of the volume of the club head 20 and preferably 10% to 30% of the mass of the club head 20.

The central member 24 preferably has a body portion 38, a recess 40, a forward surface 42, a rear surface 43, a sole surface 44, a top surface 46, a toe surface 48, a heel surface 50 and a flange 52. The forward surface 42 is preferably at an angle approximate that of the club head 20. Thus, if the club head 20 is a 5-iron, then the forward surface preferably has an angle of approximately 27 degrees. The body portion 38 preferably tapers upward from the sole surface 44.

The central member 24 is disposed on an interior surface of the sole wall 28 of the periphery member 22. The toe surface 48 of the central member 24 preferably engages the interior surface of the toe wall 30 of the periphery member 22. The heel surface 50 of the central member 24 preferably engages the heel wall 32 of the periphery member 22. The top surface 46 preferably creates the top line of the club head 20. The flange 52 extends from the top surface 46 outward over the forward surface 42 thereby creating a top cover for securing the face plate 26. The face plate 26 is also secured within a ledge 60 of the periphery member 22.

The face plate 26 is preferably composed of a light-weight material. Such materials include titanium materials, stainless steel, amorphous metals and the like. Such titanium materials include pure titanium and titanium alloys such as 6-4 titanium alloy, 6-22-22 titanium alloy, 4-2 titanium alloy, SP-700 titanium alloy (available from Nippon Steel of Tokyo, Japan), DAT 55G titanium alloy available from Diado Steel of Tokyo, Japan, Ti 10-2-3 Beta-C titanium alloy available from RTI International Metals of Ohio, and the like. The face plate 26 is preferably manufactured through casting, forging, forming, machining, powdered metal forming, metal-injection-molding, electrochemical milling, and the like.

The face plate 26 has an interior surface 56 which preferably engages the forward surface 42 of the central member 24, and an exterior surface 54 which preferably has scorelines (not shown) thereon. The face plate preferably has a thickness that ranges from 0.04 inch to 0.250 inch, more preferably from 0.06 inch to 0.130 inch and most preferably 0.075 inch.

The club head 20 preferably has a total volume that ranges from 40.0 cm³ to 60.0 cm³, more preferably from 45.0 cm³ to 55.0 cm³, and most preferably 50.8 cm³. The club head 20 preferably has a mass that ranges from 240 grams to 270 grams, more preferably from 245 grams to 260 grams, and most preferably 253 grams.

The periphery member 22 preferably has a total volume that ranges from 10.0 cm³ to 32.0 cm³, more preferably from 15.0 cm³ to 20.0 cm³, and most preferably 18.8 cm³. The periphery member 22 preferably has a mass that ranges from 100 grams to 240 grams, more preferably from 150 grams to 200 grams, and most preferably 185 grams.

The central member 24 preferably has a total volume that ranges from 7.0 cm³ to 35.0 cm³, more preferably from 15.0 cm³ to 30.0 cm³, and most preferably 28.0 cm³. The central member 24 preferably has a mass that ranges from 9 grams to 70 grams, more preferably from 25 grams to 60 grams, and most preferably 45 grams.

The face plate 26 preferably has a total volume that ranges from 4.0 cm³ to 8.0 cm³, more preferably from 4.5 cm³ to 6.0 cm³, and most preferably 5.3 cm³. The face plate 26 preferably has a mass that ranges from 15 grams to 50 grams, more preferably from 20 grams to 30 grams, and most preferably 24 grams.

The center of gravity and the moment of inertia of a golf club head 20 are preferably measured using a test frame (X^{T}, Y^{T}, Z^{T}), and then transformed to a head frame (X^{H}, Y^{H}, Z^{H}). The center of gravity of a golf club head 20 may be obtained using a center of gravity table having two weight scales thereon, as disclosed in co-pending U.S. patent application Ser. No. 09/796,951, filed on Feb. 27, 2001, entitled High Moment Of Inertia Composite Golf Club, and hereby incorporated by reference in its entirety. If a shaft is present, it is removed and replaced with a hosel cube that has a multitude of faces normal to the axes of the golf club head. Given the weight of the golf club head, the scales allow one to determine the weight distribution of the golf club head when the golf club head is placed on both scales simultaneously and weighed along a particular direction, the X, Y or Z direction.

In general, the moment of inertia, Izz, about the Z axis for the golf club head 20 preferably ranges from 2200 g-cm² to 3000 g-cm², more preferably from 2400 g-² to 2700 g-cm², and most preferably from 2472 g-cm² to 2617 g-cm². The moment of inertia, Iyy, about the Y axis for the golf club head 20 preferably ranges from 400 g-cm² to 700 g-cm², more preferably from 500 g-cm² to 600 g-cm², and most preferably from 530 g-cm² to 560 g-cm². The moment of inertia, Ixx, about the X axis for the golf club head 20 preferably ranges from 2450 g-cm² to 3200 g-cm², more preferably from 2500 g-cm² to 2900 g-cm², and most preferably from 2650 g-cm² to 2870 g-cm².

For comparison, the new BIG BERTHA® 5-iron from Callaway Golf Company has a moment of inertia, Izz, of 2158 g-cm², a moment of inertia, Iyy, of 585 g-cm², and a moment of inertia, Ixx, of 2407 g-cm².

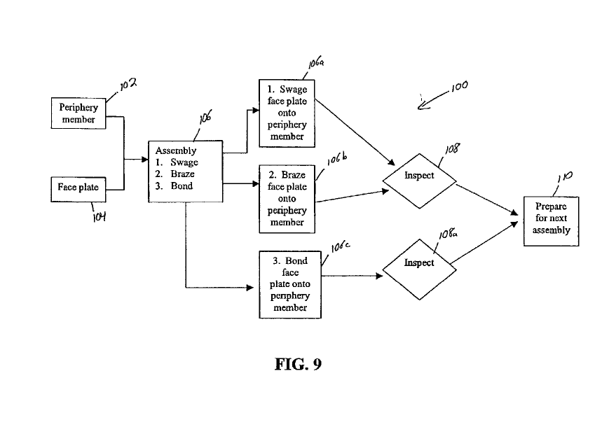

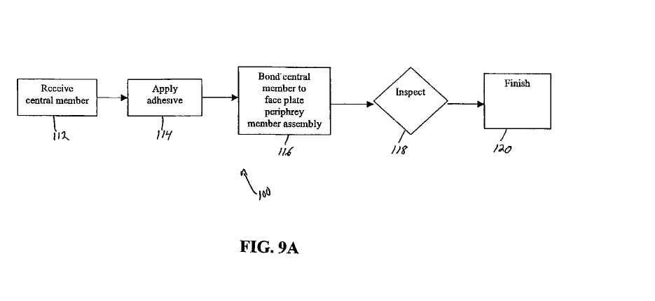

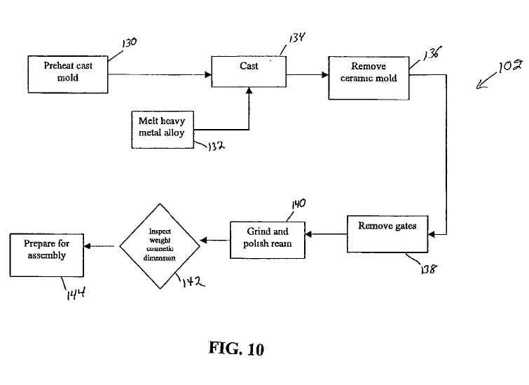

In manufacturing the iron golf club head 20, the three main components are preferably prepared first, and then assembled into the club head 20. The face plate 26 is preferably stamped or hot-formed. Scorelines are preferably created with the forming process, however, the scorelines may alternatively may machined in after the forming process. The fabrication processes of the periphery member and central member are set forth in the flow charts of FIGS. 10-13. The main assembly process 100 is set forth in FIGS. 9 and 9A.

The process 100 commences with forming the periphery member 22 at box 102 and forming the face plate 26 at box 104. Next, at box 106 the face plate 26 is assembled with the periphery member 22 to form a base assembly. Three preferred options for assembly include swaging, brazing and bonding.

At box 106a, the face plate 26 is swaged into the periphery member 22. This option includes deforming the face plate 26 to fit and roll the face plate 26 over the edges of the periphery member 22, or using a brass locking ring to fit and lock the face plate 26 to the periphery member 22. At alternative box 106b, the face plate 26 is positioned in the periphery member 22, and then brazed with a titanium nitride foil or paste. At alternative box 106c, an adhesive such as an epoxy, is applied to the contact surfaces of the face plate 26 and the periphery member 22, and then the face plate 26 is bonded to the periphery member 22. Next, at boxes 108 or 108a, the base assembly is inspected to ensure proper attachment of the face plate 26 to the periphery member 22. At box 110 the base assembly is prepared for the next assembly through polishing and/or grinding.

At box 112 the central member 24 is prepared and received for assembly. At box 114 an adhesive such as DP810 acrylate or DP420 epoxy adhesives, both from 3M Company, are applied to the central member 24 and the base assembly. Next, at box 116, the central member 24 is bonded to the base assembly of the face plate 26 and the periphery member 22 to create a final assembly. At box 118, the final assembly is inspected and at box 120 the iron golf club head 20 is finished.

FIG. 10 illustrates a preferred process 102 for forming the periphery member 22. At box 130, a cast mold is heated. At box 132, a heavy metal alloy is melted to pour into the mold. At box 134, the alloy is poured into the mold and the periphery member precursor is cast. At box 136 the ceramic mold is removed. At box 138, the gates are removed from the periphery member precursor. At box 140, the periphery member 22 is ground and polished. At box 142, the periphery member is inspected. At box 144, the periphery member 22 is prepared for assembly.

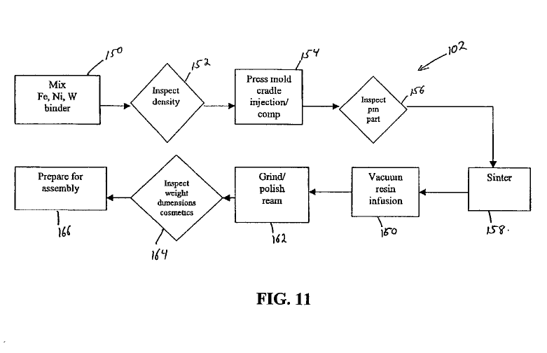

FIG. 11 illustrates an alternative process for forming the periphery member through use of metal injection molding, powdered metal formation or liquid infiltration. At box 150, the alloys mixed, and in a specific preferred example tungsten iron and nickel are mixed. At box 152 the density of the alloy is measured. At box 154, the periphery member precursor is compression molded or injection molded. At box 156 this precursor is inspected. At box 158, the periphery member precursor is sintered for metal injection molding or with liquid infiltration the precursor is infiltrated with a liquid metal. At box 160, the periphery member is vacuum resin infused if a powder metal formation process is used in order to reduce porosity. Box 160 is not preferably used for metal injection molding or liquid infiltration. At box 162 the periphery member precursor is ground and/or polished. At box 164, the periphery member is inspected and at box 166 is the periphery member 22 is prepared for assembly.

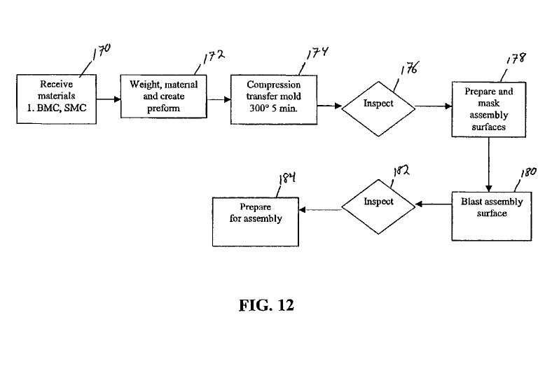

FIG. 12 is a flow chart of a preferred formation process for the central member 24. At box 170, the materials for the central member 24 are received, and these materials can include bulk molding compounds, sheet molding compounds, thermosetting materials and thermoplastic materials as discussed above. At box 172, the material is weighed and a preform of the central member is created from the material. At box 174, the preform is compression transfer molded at approximately 300 degrees Celsius for approximately five minutes. At box 176, this molded preform is inspected. At box 178, the preform is prepared and masked for blasting. At box 180, the central member precursor is blasted to remove excess materials. At box 182, the central member 22 is inspected and at box 184 it is prepared for assembly.

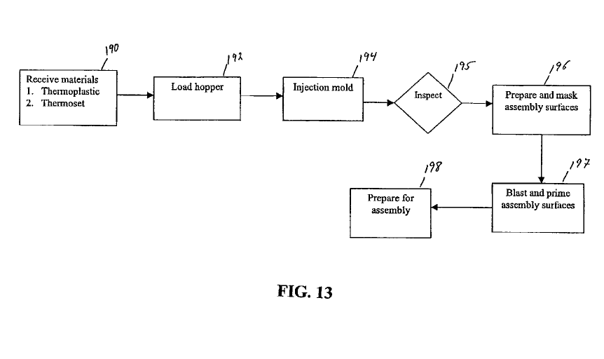

FIG. 13 is a flow chart of an alternative formation process for the central member 24. At box 190, the materials for the central member 24 are received, and these materials can include thermosetting materials and thermoplastic materials as discussed above. At box 192, the materials are loaded into the hopper. At box 194, the materials are injection molded into a central member precursor. At box 195, this precursor is inspected. At box 196, the precursor is prepared and masked for blasting. At box 197, the central member precursor is blasted to remove excess materials. At box 198, the central member 24 is prepared for assembly.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A method for manufacturing an iron golf club head, the method comprising:
attaching a face plate to a periphery member to create a base assembly, the periphery member having a sole wall, a toe wall extending upward from the sole wall at a first end of the sole wall, a hosel extending upward from the sole wall at a second end of the sole wall, and a heel wall extending upward from the sole wall, the periphery member composed of a metal material having a density ranging from 8 g/cm³ to 11 g/cm³; and
bonding a central member to the base assembly, the central member having a body portion with a forward surface, a sole surface, a top surface, a toe surface, a heel surface and a flange extending from the top surface at an intersection of the top surface and the forward surface, the central member having a rear cavity defined by the body portion, the central member composed of a non-metal material having a density ranging from 0.9 g/cm³ to 2.5 g/cm³.

2. The method according to claim 1 wherein the face plate is composed of a titanium alloy material and has a thickness ranging from 0.050 inch to 0.250 inch.

3. The method according to claim 1 wherein the central member is composed of a bulk molding compound.

4. The method according to claim 1 wherein the periphery member is composed of an iron-nickel-tungsten alloy.

5. The method according to claim 1 wherein the central member has a volume percentage of the golf club head ranging from 25% to 75%, and a mass percentage of the golf club head ranging from 10% to 30%.

6. The method according to claim 1 wherein the periphery member has a volume percentage of the golf club head ranging from 15% to 50%, and a mass percentage of the golf club head ranging from 50% to 80%.

7. A method for manufacturing an iron golf club head, the method comprising:
attaching a metal face plate to a metal periphery member to create a base assembly, the periphery member having a sole wall, a toe wall extending upward from the sole wall at a first end of the sole wall, a hosel extending upward from the sole wall at a second end of the sole wall, and a heel wall extending upward from the sole wall, the periphery member composed of a metal material having a density ranging from 8 g/cm³ to 11 g/cm³ and bonding a non-metal central member to the base assembly, the central member having a body portion with a forward surface, a sole surface, a top surface, a toe surface, a heel surface and a flange extending from the top surface at an intersection of the top surface and the forward surface, the central member having a rear cavity defined by the body portion, the forward surface of the central member adhered to tan interior surface of the face plate and the flange of the central member adhered to an upper perimeter of the face plate, the central member composed of a non-metal material having a density ranging from 0.9 g/cm³ to 2.5 g/cm³.

8. The method according to claim 7 wherein attaching the face plate to the periphery member comprises swaging the face plate onto the periphery member by deforming the face plate or the periphery member.

9. The method according to claim 7 wherein attaching the face plate to the periphery member comprises brazing the face plate to the periphery member.

10. The method according to claim 7 wherein attaching the face plate to the periphery member comprises adhering the face plate to the periphery member with an adhesive.

11. The method according to claim 7 wherein attaching the face plate to the periphery member comprises swaging the face plate onto the periphery member by use of a brass locking ring.
